(19) United States
(12) Patent Application Publication
(10) Pub. No.: US 2026/0098953 A1
(43) Pub. Date: Apr. 9, 2026

(54) RADIO RESOURCE MANAGEMENT (RRM) ENHANCEMENTS BASED ON NARROWBAND (NB) FREQUENCY MODULATED CONTINUOUS WAVE (FMCW)

(71) Applicant: QUALCOMM Incorporated, San Diego, CA (US)

(72) Inventors: Weimin DUAN, San Diego, CA (US); Kangqi LIU, San Diego, CA (US); Jing LEI, San Diego, CA (US)

(21) Appl. No.: 18/909,753

(22) Filed: Oct. 8, 2024

(51) Int. Cl. G01S 13/34; G01S 7/35; H04L 5/00; H04W 72/0453; H04W 72/30

(52) U.S. Cl. CPC G01S 13/34; G01S 7/352; H04L 5/0048; H04W 72/0453; H04W 72/30

(57) ABSTRACT

A method for wireless communication by a user equipment (UE) includes receiving a first narrowband frequency modulated continuous wave (FMCW) reference signal from a first network device. The first FMCW reference signal has a pre-specified bandwidth. The method also includes receiving a second narrowband frequency modulated continuous wave (FMCW) reference signal from a second network device. The second FMCW reference signal has the pre-specified bandwidth and is multiplexed with the first FMCW reference signal. The method further includes performing one-shot radio resource management (RRM) measurement based on the first FMCW reference signal and the second FMCW reference signal.

### FIELD OF THE DISCLOSURE

The present disclosure relates generally to wireless communications, and more specifically to radio resource management (RRM) enhancements based on narrowband (NB) frequency modulated continuous wave (FMCW) transmissions.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and long-term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IOT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a fifth generation (5G) Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication by a user equipment (UE) includes receiving a first narrowband frequency modulated continuous wave (FMCW) reference signal from a first network device. The first FMCW reference signal has a pre-specified bandwidth. The method also includes receiving a second narrowband frequency modulated continuous wave (FMCW) reference signal from a second network device. The second FMCW reference signal has the pre-specified bandwidth and is multiplexed with the first FMCW reference signal. The method further includes performing one-shot radio resource management (RRM) measurement based on the first FMCW reference signal and the second FMCW reference signal.

Other aspects of the present disclosure are directed to an apparatus. The apparatus has one or more memories and one or more processors coupled to the one or more memories. The processor(s) is configured to receive a first narrowband frequency modulated continuous wave (FMCW) reference signal from a first network device. The first FMCW reference signal has a pre-specified bandwidth. The processor(s) is also configured to receive a second narrowband frequency modulated continuous wave (FMCW) reference signal from a second network device. The second FMCW reference signal has the pre-specified bandwidth and is multiplexed with the first FMCW reference signal. The processor(s) is further configured to perform one-shot radio resource management (RRM) measurement based on the first FMCW reference signal and the second FMCW reference signal.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a graph illustrating a frequency modulated continuous wave (FMCW) transmitted on a carrier across a bandwidth.

FIG. 5 is a block diagram illustrating FMCW signal mixing.

FIG. 6 is a graph illustrating FMCW processing.

FIG. 7 is a graph illustrating FMCW signals after FMCW mixing.

FIG. 8 illustrates graphs showing UE behaviors for FMCW receiver processing.

FIG. 9 is a graph illustrating multiple FMCW transmissions, in accordance with various aspects of the present disclosure.

FIG. 10 is a graph illustrating a gap between narrowband FMCWs, according to various aspects of the present disclosure.

FIG. 11 is a graph illustrating narrowband FMCWs and corresponding beat signal clusters, according to aspects of the present disclosure.

FIG. 12 illustrates narrowband FMCW cyclical sweeping across cells, in accordance with various aspects of the present disclosure.

FIG. 13 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with fifth generation (5G) and later wireless technologies, aspects of the present disclosure can be applied in other generation-based communications systems, such as and including third generation (3G) and/or fourth generation (4G) technologies.

A frequency modulated continuous wave (FMCW) is a continuous signal having a frequency that changes over time. For example, the frequency may increase (up-chirp) or decrease (down-chirp) with time. In some aspects, the increase or decrease may occur linearly. The frequency of the FMCW signal may be modulated or swept within a specific frequency range or bandwidth (e.g., ranging from a lower frequency to a higher frequency) in a continuous manner.

Radio resource management (RRM) includes procedures for cell search, cell reselection, handover, radio link monitoring, connection establishment, etc. For example, synchronization signal block (SSB) processing is part of an initial access procedure for user equipment (UEs). It would be desirable to employ narrowband FMCWs to enhance existing RRM procedures.

To enable network synchronization, a network may transmit an SSB over a channel to a UE, allowing the UE to perform measurements on the SSB, for example, to assess the channel conditions. The SSB based measurement quantities are narrowband measurements, which rely on a long-term average to mitigate the channel fading effects. The long-term average requirement causes the UE to wake up more frequently for RRM measurement reporting, consuming more power. According to aspects of the present disclosure, a network may transmit narrowband FMCW signals from multiple network nodes (e.g., base stations or gNBs) to enable the UE to perform narrowband RRM measurements during a brief synchronization signal (SS)/physical broadcast channel (PBCH) block measurement timing configuration (SMTC) measurement duration. According to these aspects, a network coordinates network nodes (e.g., gNBs) from different cells to transmit multiple narrowband FMCWs within a short SMTC window.

In some aspects, the SMTC window for the narrowband FMCWs is less than one millisecond (1 ms), allowing the UE to wake up for less time for the RRM measurements. For example, the SMTC window may have a length of one symbol. During the SMTC window, the UE measures all received frequency tones, and thus measures all cells or carriers during that short period of time.

The narrowband FMCW may be multiplexed in time, frequency, or in a code domain to enable all carriers/cells to be measured during a single SMTC window. According to aspects of the present disclosure, frequency division multiplexed (FDM) narrowband FMCWs specify a minimum gap between the closest narrowband FMCWs. The gap may be based on propagation distance. The gap between cells avoids measurement ambiguity due to propagation delay and residual frequency offset. In some cases, the frequency domain gap between different cells may be relaxed due to resource restrictions. In these cases, another multiplexing method is needed, such as time division multiplexing (TDM) or code division multiplexing (CDM).

Particular aspects of the subject matter described in this disclosure can be implemented to realize one or more of the following potential advantages. In some examples, the described techniques, such as one-shot radio resource management (RRM) measurement based on narrowband frequency modulated continuous waves (FMCWs) may decrease UE power consumption, release resources for other data and control traffic, and reduce system latency.

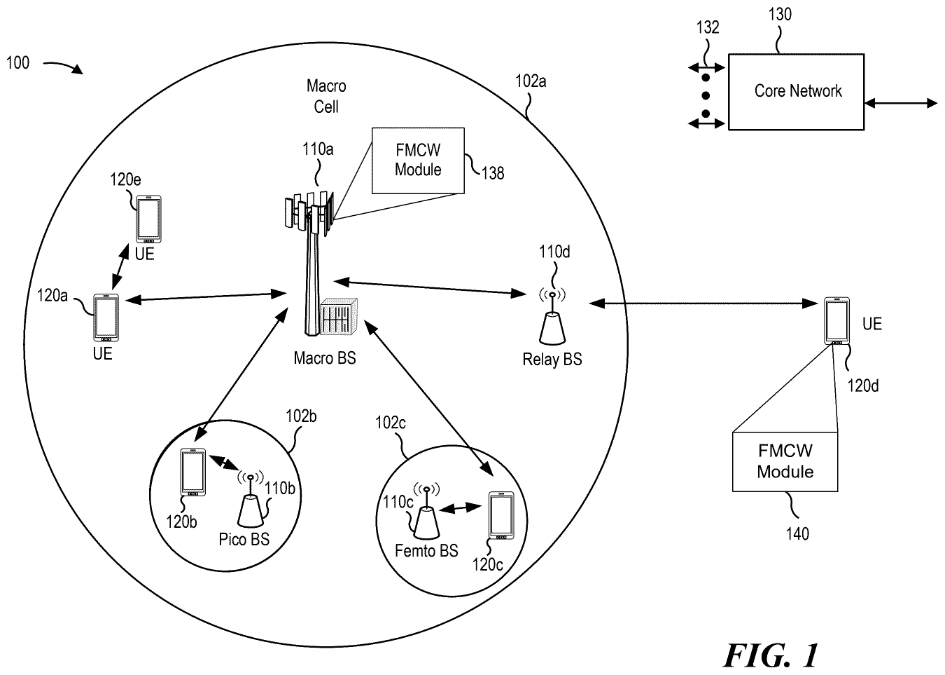

FIG. 1 is a diagram illustrating a wireless network 100 in which aspects of the present disclosure may be practiced. The wireless network 100 may be a 5G or new radio (NR) network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include an FMCW module 140. For brevity, only one UE 120d is shown as including the FMCW module 140. The FMCW module 140 may receive a first narrowband frequency modulated continuous wave (FMCW) reference signal from a first network device. The first FMCW reference signal has a pre-specified bandwidth. The FMCW module 140 may also receive a second narrowband frequency modulated continuous wave (FMCW) reference signal from a second network device. The second FMCW reference signal has the pre-specified bandwidth and is multiplexed with the first FMCW reference signal. The FMCW module 140 may further perform one-shot radio resource management (RRM) measurement based on the first FMCW reference signal and the second FMCW reference signal.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IOT) devices, and/or may be implemented as NB-IOT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

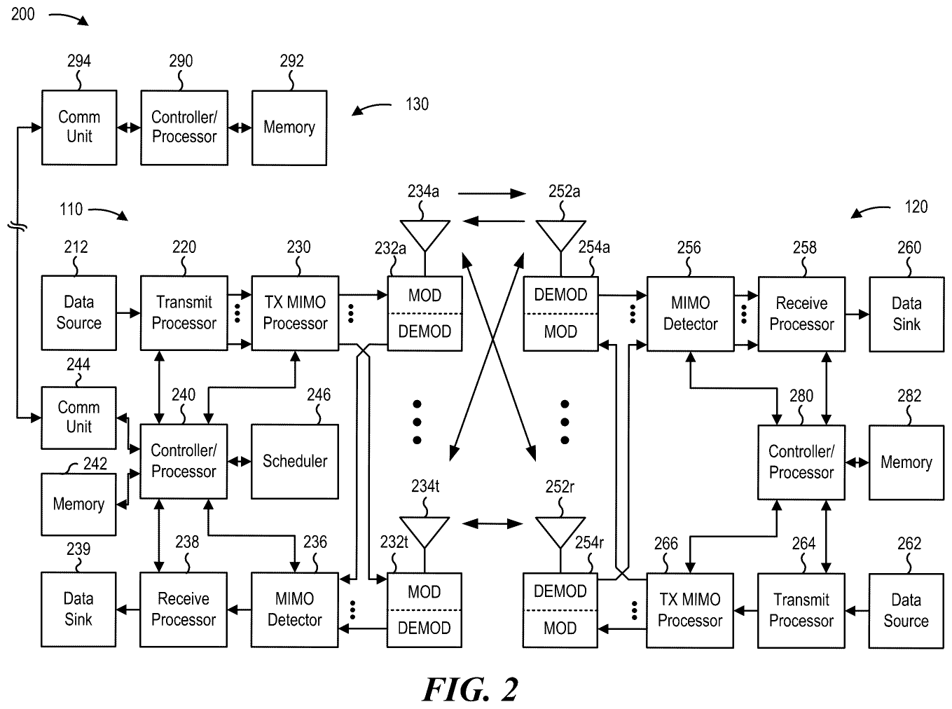

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

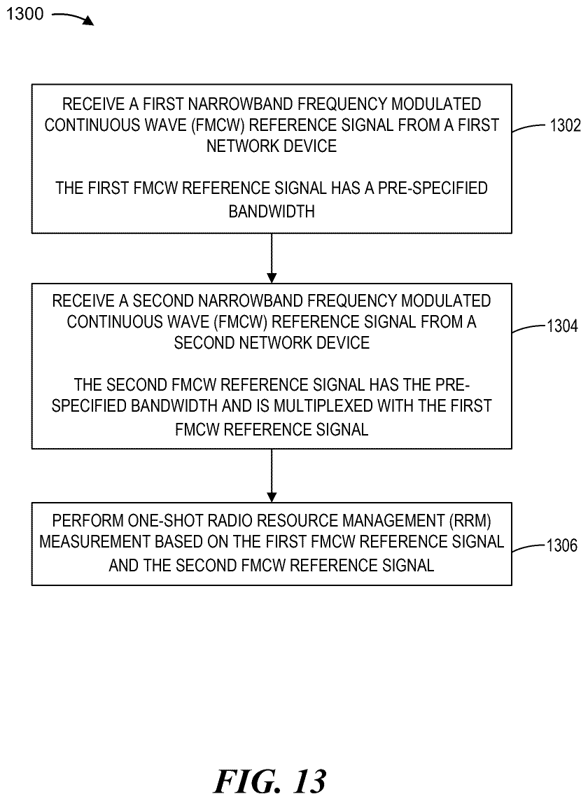

The controller/processor 240 of the base station 110, the controller/processor 280 of the UE 120, and/or any other component(s) of FIG. 2 may perform one or more techniques associated with narrowband FMCW processing, as described in more detail elsewhere. For example, the controller/processor 240 of the base station 110, the controller/processor 280 of the UE 120, and/or any other component(s) of FIG. 2 may perform or direct operations of, for example, the process of FIG. 13 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for performing, means for mixing, and means for matching. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IOT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

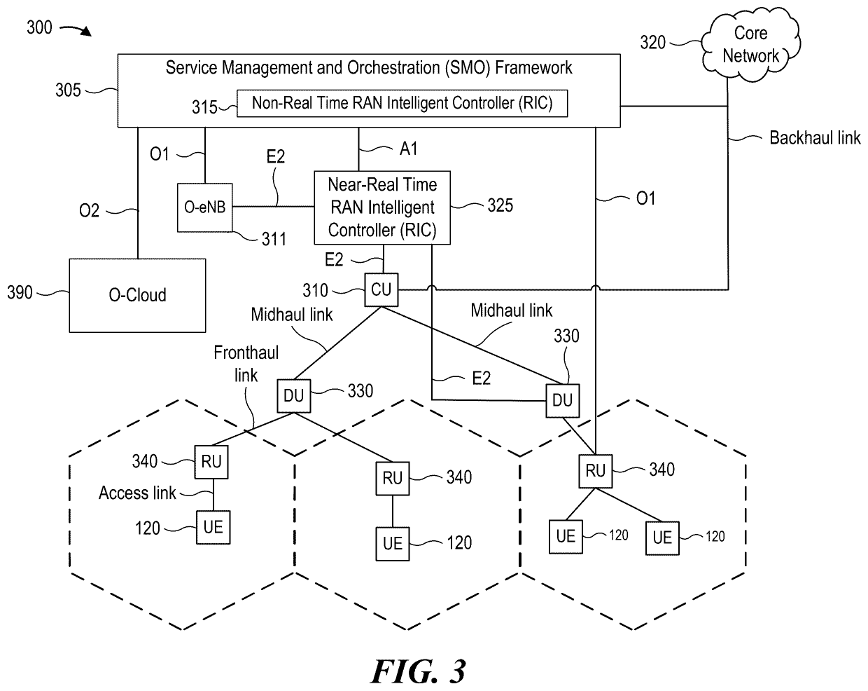

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via 01) or via creation of RAN management policies (such as A1 policies).

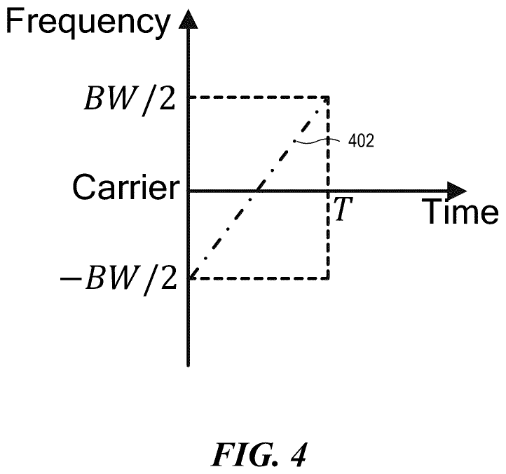

A frequency modulated continuous wave (FMCW) is a continuous signal having a frequency that changes over time. For example, the frequency may increase (up-chirp) or decrease (down-chirp) with time. In some aspects, the increase or decrease may occur linearly. The frequency of the FMCW signal may be modulated or swept within a specific frequency range or bandwidth (e.g., ranging from a lower frequency to a higher frequency) in a continuous manner. FIG. 4 is a graph illustrating an FMCW 402 transmitted on a carrier across a bandwidth (BW), starting at frequency—BW/2 and increasing to frequency BW/2 over a duration T.

Advantages of an FMCW include the ability for wideband (WB) sensing or channel estimating using a narrowband baseband processing. Moreover, low-speed analog-to-digital converters (ADCs) may sample a beat signal, from several gigahertz (GHz) to less than 10 megahertz (MHz). Additionally, a low peak-to-average power ratio (PAPR) facilitates low complexity, full duplex sensing.

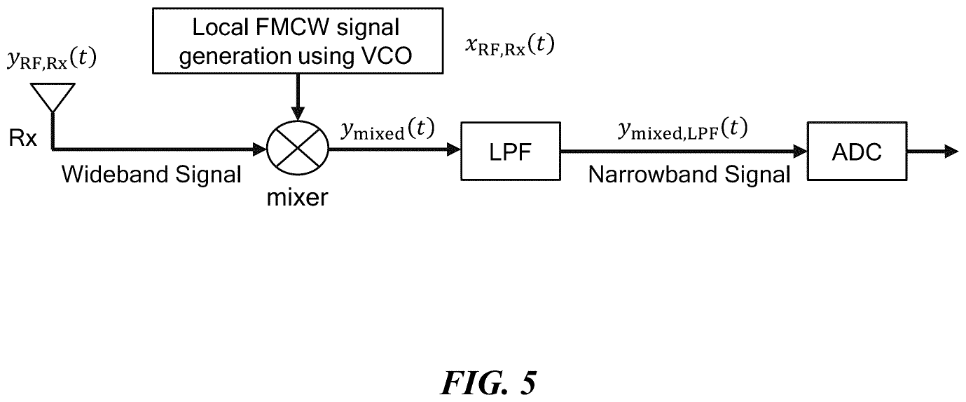

FIG. 5 is a block diagram illustrating FMCW signal mixing. In the example of FIG. 5, a received signal y_{RF,Rx}(t) passes from a receiver (Rx) to a mixer. In some cases, the received signal y_{RF,Rx}(t) is a wideband signal, but may also be a narrowband signal, in accordance with aspects of the present disclosure. The mixer mixes the received signal y_{RF,Rx}(t) at time t with a local FMCW signal X_{RF,Rx}(t) generated with a voltage controlled oscillator (VCO) to obtain a mixed signal, also referred to as a beat signal y_{mixed}(t). A low pass filter (LPF) filters the beat signal y_{mixed}(t) to obtain a filtered beat signal y_{mixed, LPF}(t). The filtered beat signal y_{mixed, LPF}(t) is a narrowband signal that is processed by an analog-to-digital convertor (ADC). In a RADAR system, the digital signal output from the ADC maps to a specific target reflection.

Radio resource management (RRM) includes procedures for cell search, cell reselection, handover, radio link monitoring, connection establishment, etc. For example, synchronization signal block (SSB) processing is part of an initial access procedure for user equipment (UEs). It would be desirable to employ narrowband FMCWs to enhance existing RRM procedures.

To enable network synchronization, a network may transmit an SSB over a channel to a UE, allowing the UE to perform measurements on the SSB, for example, to assess the channel conditions. According to aspects of the present disclosure, a network may transmit FMCW signals from multiple base stations to enable the UE to perform RRM measurements during a brief synchronization signal (SS)/physical broadcast channel (PBCH) block measurement timing configuration (SMTC) measurement duration.

An FMCW based detector for a pre-synchronization signal block (SSB) FMCW includes a single transmitter sweep with a long receiver sweep. The network transmits an FMCW based primary synchronization signal (PSS) over a set of raster points (fᵢ). Unlike a conventional SSB, the transmitted FMCW does not include cell information. The UE is able to identify a time and frequency of the signal with a mixer, and without synchronization.

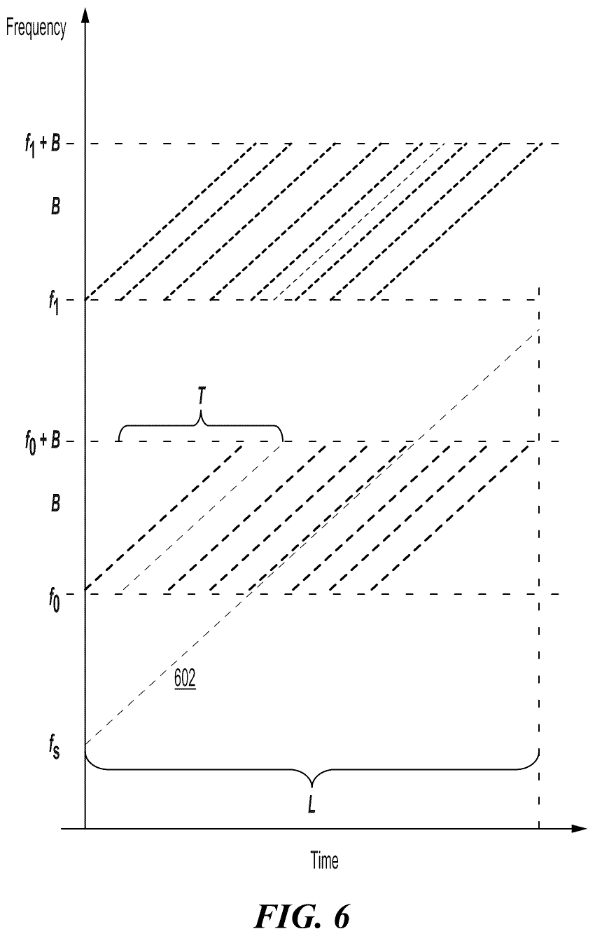

FIG. 6 is a graph illustrating FMCW processing. In the example of FIG. 6, an FMCW duration is shown as T and an FMCW bandwidth is shown as B. The duration may have a length of a single symbol. A transmitter sweep starts from frequency fᵢ and ends at frequency fᵢ+B, where fᵢ represents the set of raster points. For example, in FIG. 6, two FMCW instances are shown where a first instance starts at frequency f₀ and ends at frequency f₀+B, and a second instance starts at frequency f₁ and ends at frequency f₁+B. The starting time of the FMCW transmission is not known at the receiver for an initial search because the receiver has not yet acquired timing knowledge. There can be multiple raster points and the UE does not know which raster point is being used.

At the receiver, the UE uses an FMCW to mix the received signal. An FMCW detector sweep 602 starts from time 0 and frequency fₛ with a slope of B/T. The sweep duration is L, where L>T. The first L−T part of the sweeping window is the effective range where the full FMCW sweep can be covered by the detector sweep 602.

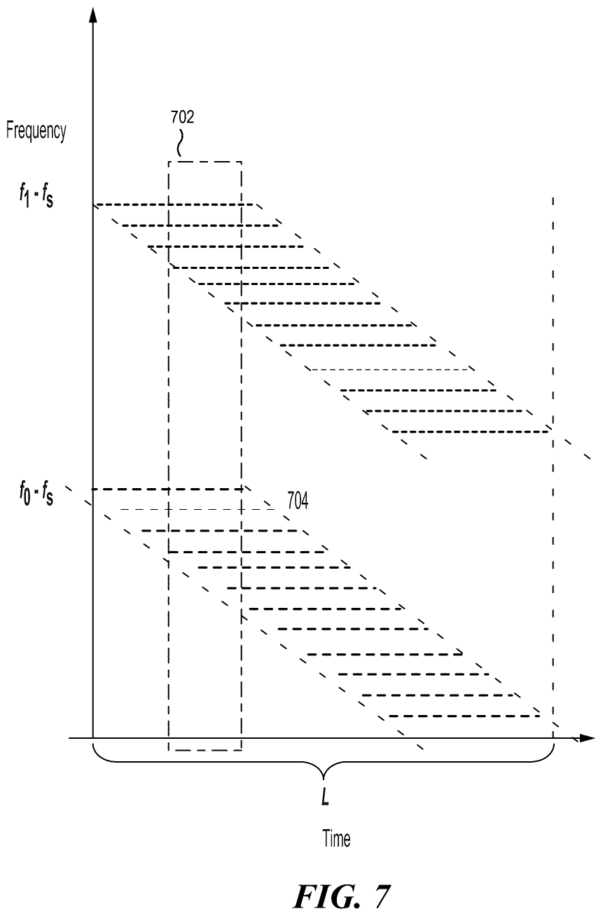

FIG. 7 is a graph illustrating FMCW signals after FMCW mixing. The FMCW may be a pre-SSB FMCW in this example. In FIG. 7, a UE processes a received signal in search window 702, window-by-window. As seen in FIG. 7, in a time or frequency domain after the FMCW mixing at the receiver, the signature of an FMCW primary synchronization signal (PSS) is a horizontal line 704 with length T, starting at time t∈[0, L−T], and frequency

$${f}_{i} - {f}_{S} - \frac{tB}{T} .$$

To identify the pattern, back-to-back fast Fourier transforms (FFTs) of duration T/2 may be performed to identify peak locations in a frequency domain. The duration T/2 is such that one of the FFT windows will capture the full pattern.

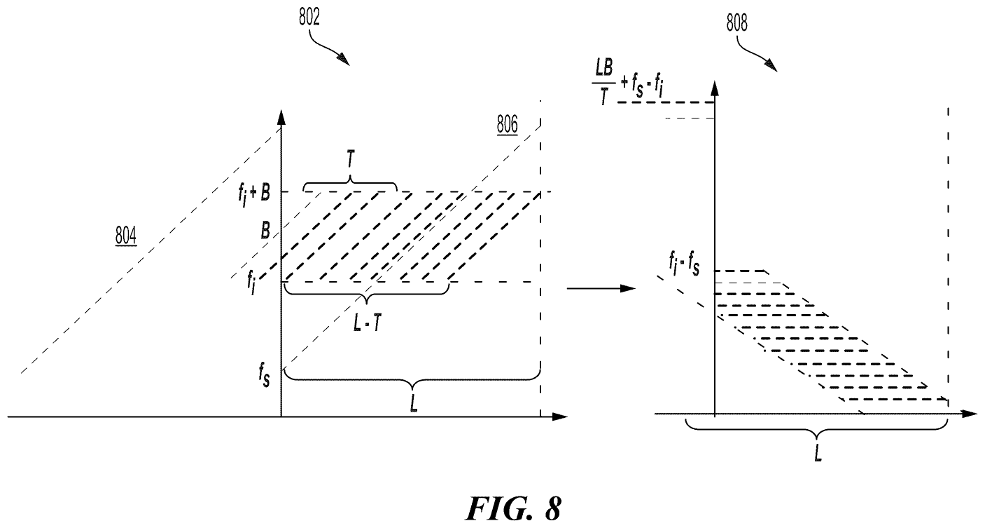

FIG. 8 illustrates graphs showing UE behaviors for FMCW receiver processing. The examples of FIG. 8 address edge cases. In a first option 802, a UE combines two back-to-back long receiver sweeps 804, 806 to enhance the detection capability for the case when the pre-SSBs FMCWs are partially covered by one long receiver sweep. In a second option 808, once the UE detects two well separated beat frequencies, the UE may adjust its local FMCW generation timing, for example, shifting by time T. Thus, the UE covers the whole pre-SSB FMCW in the next transmission cycle. In the second option 808 of FIG. 8,

$$\frac{LB}{T} + {f}_{s} - {f}_{i}$$

represents the beat signal frequency measured from the previous back-to-back search.

In 5G new radio (NR) deployments, RRM can be based on SSB measurements or channel state information reference signal (CSI-RS) measurements. However, CSI-RS-based RRM measurements are not broadly considered for 5G deployments. Most networks use SSB measurements for RRM. The SSB-based measurement quantities are narrowband measurements, which rely on a long-term average to mitigate the channel fading effects. The long-term average requirement causes the user equipment (UE) to wake up more frequently for RRM measurement reporting, consuming more power. Example measurements include reference signal received power (RSRP), reference signal received quality (RSRQ), and signal interference and noise ratio (SINR).

For some sixth generation (6G) network use cases, the UE may measure multiple carriers across a wide band, which may be wider than a 5G bandwidth. Currently, multiple SSB-based RRM measurements for a wideband carrier are not supported in 3GPP Release 15. For inter-frequency measurements, a synchronization signal block measurement timing configuration (SMTC) configuration is signaled for each frequency (e.g., one SMTC for each component carrier). If the UE could measure multiple cells spanning a wideband channel in one shot, the number of measurement gaps for RRM could be greatly reduced. This one-shot measurement (or reduced number of measurement gaps) releases more time and/or frequency resources for other data traffic and/or control traffic, reduces the latency of the system, and saves UE power.

According to aspects of the present disclosure, enhanced RRM procedures are based on narrowband FMCW measurements. In some aspects, the UE may perform a one-shot RRM measurement on FMCW reference signals across multiple cells or carriers. A “one-shot” RRM measurement may refer to a single measurement instance.

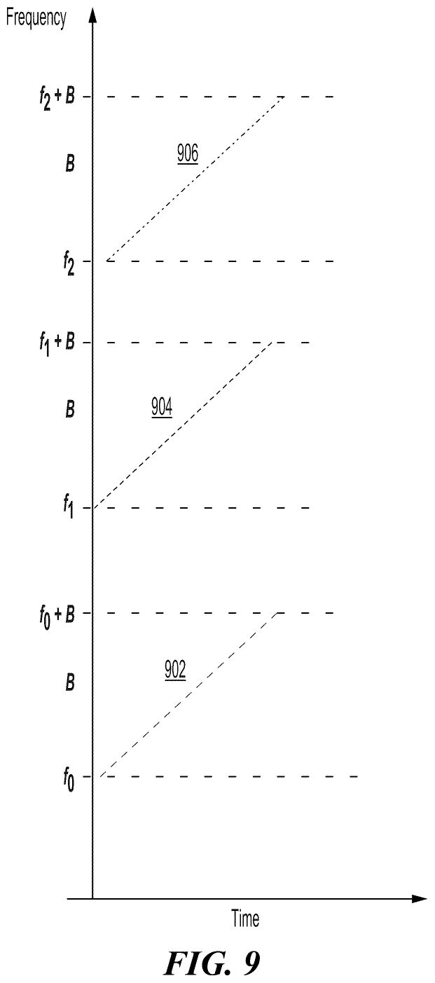

FIG. 9 is a graph illustrating multiple FMCW transmissions, in accordance with various aspects of the present disclosure. In the example of FIG. 9, RRM may be based on narrowband FMCW transmissions from multiple cells or carriers. According to these aspects, a network coordinates network nodes (e.g., base stations or gNBs) from different cells to transmit multiple narrowband FMCWs within a short SMTC window. As seen in FIG. 9, a first FMCW 902 from a first network node is transmitted from frequency f₀ to frequency f₀+B. A second network node transmits a second FMCW 904 from frequency f₁ to frequency f₁+B. A third network node transmits a third FMCW 906 from frequency f₂ to frequency f₂+B.

In some aspects, the SMTC window for the narrowband FMCWs is smaller than one millisecond (1 ms), allowing the UE to wake up for less time for the RRM measurements. For example, the SMTC window may have a length of one symbol. That is, the SMTC window may be defined at the symbol level, instead of at the millisecond level. The short window allows the UE to conserve power. During the window, the UE measures all received frequency tones, and thus measures all cells or carriers during that short period of time. The narrowband FMCWs from different cells are transmitted within a symbol (e.g., when the SMTC window is a symbol level) to reduce the UE wake-up time for RRM measurement.

The narrowband FMCW may be multiplexed in time, frequency, or in a code domain. By applying a time, code, or frequency domain scrambling on the narrowband FMCW, all carriers/cells may be measured during a single window. The network signals the neighboring cell narrowband FMCW time, frequency, or code information to the UE to enable the UE to process the detected narrowband FMCWs. For example, a serving cell may signal the scrambling information to the UE.

To simplify the UE receiver, a common slope is present across all cells. In some aspects, however, a different slope exists for each cell or some cells, specifying multiple receive chains at UE.

To further simplify the UE receiver, a default value of the bandwidth “B” is specified in the standards. The bandwidth may depend on the numerology of the secondary synchronization signal (SSS) or physical broadcast channel (PBCH), or the respective frequency band. That is, a per frequency band definition or a per subcarrier spacing (SCS) definition may be standardized. A larger bandwidth is needed as carrier frequency increases, because the coherence bandwidth increases with carrier frequency.

According to aspects of the present disclosure, frequency division multiplexed (FDM) narrowband FMCWs specify a minimum gap between the closest narrowband FMCWs. The gap may be based on propagation distance. For example, a gap between cells

$${f}_{i + 1} - {f}_{i} > RST {D}_{i , i + 1} * \frac{B}{T} ,$$

where KSTD_{i,i+1} is a maximum receive signal time difference (from the UE's perspective) from the cells transmitting narrowband FMCWs closest in the frequency domain. The gap between cells fᵢ₊₁-fᵢ avoids measurement ambiguity due to propagation delay and residual frequency offset. The receive signal time difference (RSTD) value implicitly indicates the synchronization error range across cells. The RSTD value also implicitly reflects the impact on residual frequency offset (including crystal oscillator (XO) and Doppler offsets).

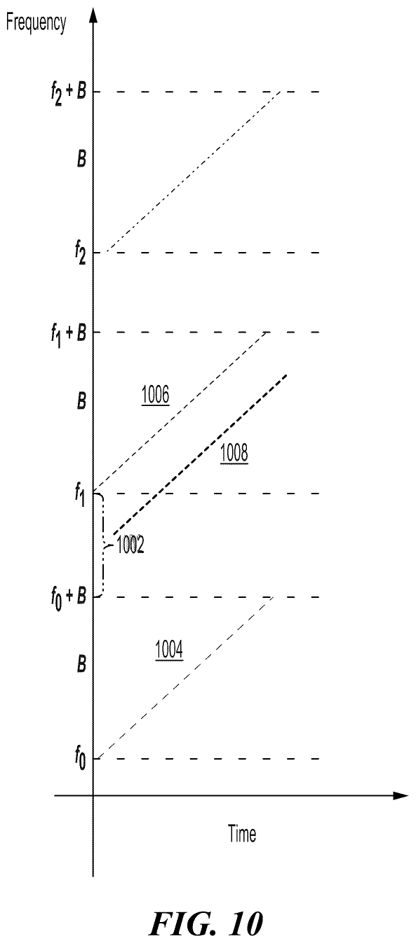

FIG. 10 is a graph illustrating a gap between narrowband FMCWs, according to various aspects of the present disclosure. In the example of FIG. 10, a gap 1002 is defined between a first FMCW 1004 from a first base station and a second FMCW 1006 from a second base station. The second FMCW 1006 is an ideal FMCW. Due to propagation delay and frequency offset, an actual second FMCW 1008 that differs from the second ideal FMCW 1006 may be observed. The gap 1002 ensures that the time and frequency shift from the second FMCW 1006 does not interfere with the first FMCW 1004.

In some cases, the frequency domain gap between different cells may be relaxed due to resource restrictions. In these cases, another multiplexing method is needed, such as time division multiplexing (TDM) or code division multiplexing (CDM). CDM may enable minimum SMTC operation for RRM, however, CDM may reduce the receiver dynamic range. Thus, the code family and code length should be well defined. CDM may include time or frequency scrambling for each narrowband FMCW. CDM may also scramble for a group of narrowband FMCWs across the cells.

UE receiver operation to enable one-shot multi-cell RRM measurement is now described in further detail. A UE may use a narrowband FMCW to mix the received signal to obtain the beat signal. Referring back to FIG. 5, the received signal y_{RF,Rx}(t) may be the narrowband FMCW transmitted by a base station at time t. The UE mixes the local FMCW signal X_{RF,Rx}(t) with the received signal y_{RF,Rx}(t) to obtain the beat signal y_{mixed}(t).

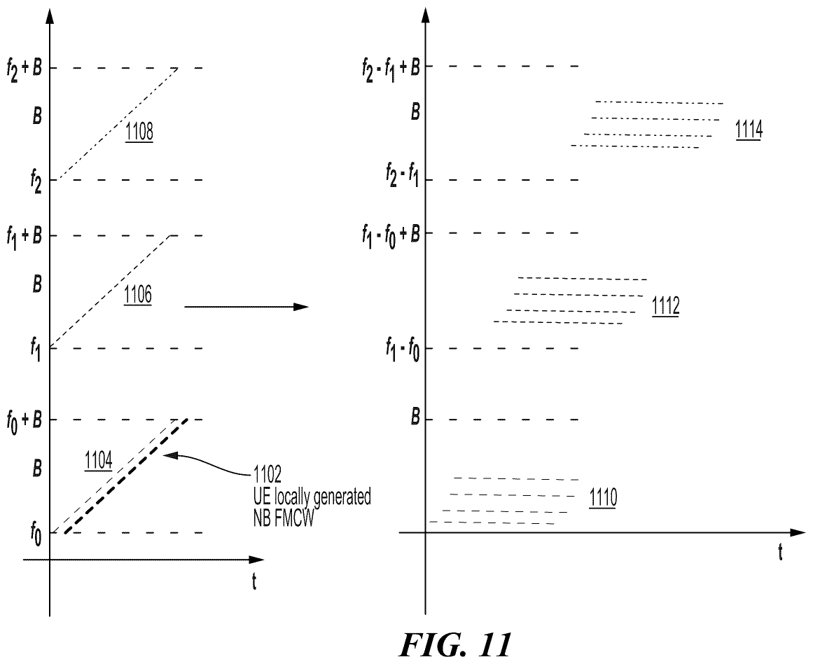

FIG. 11 is a graph illustrating narrowband FMCWs and corresponding beat signal clusters, according to aspects of the present disclosure. Using the time, frequency, or code information for narrowband FMCWs 1104, 1106, 1108 transmitted from each cell, the UE generates a narrowband FMCW 1102 to mix with the received narrowband FMCWs 1104, 1106, 1108 in order to generate beat signal clusters 1110, 1112, 1114. The beat signal clusters 1110, 1112, 1114 match specific cell RRM measurements, such as RSRP, RSRQ, etc. As shown in FIG. 11, each cluster of beat signal clusters 1110, 1112, 1114 corresponds to a multipath delay from different cells. The UE calculates power from each tone of the beat signal clusters 1110, 1112, 1114 and combines the results to obtain the raw measurements (e.g., RSRP, RSRQ, etc.) for processing, which is similar to SSB processing.

In some aspects, the UE may use a small number of additional sweep windows to reduce the impact of timing error in non-serving cells. The UE may use standardized network assistance information, for example, “RSTD_{i,i+1} uncertainty”, from positioning protocol standards to select the window.

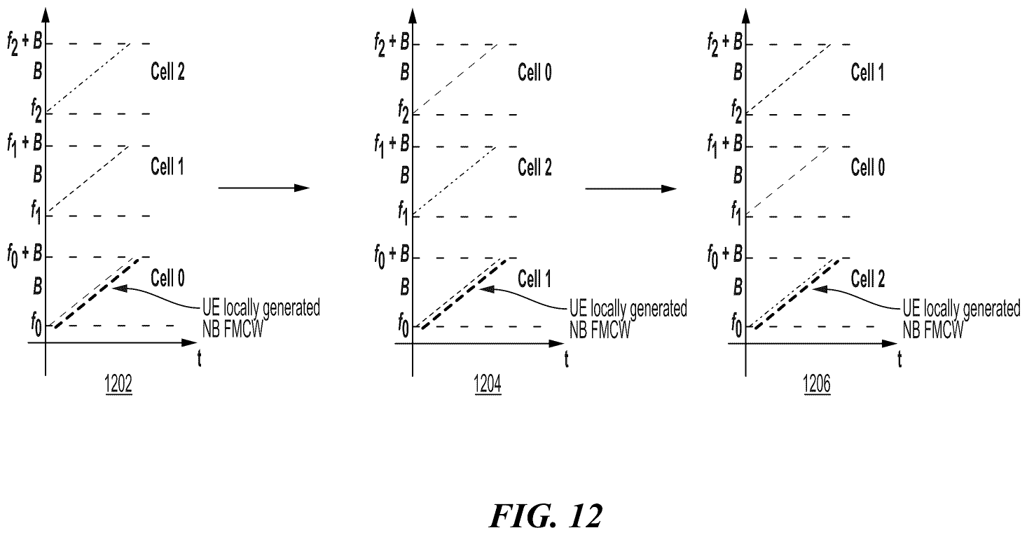

FIG. 12 illustrates narrowband FMCW cyclical sweeping across cells, in accordance with various aspects of the present disclosure. To harvest the frequency diversity in the wideband, the narrowband FMCW may be cyclically transmitted across cells. For example, as seen in FIG. 12, during a first measurement 1202, a first cell (cell 0) transmits a first FMCW from frequency f₀ to frequency f₀+B. A second cell (cell 1) transmits a second FMCW from frequency f₁ to frequency f₁+B, and a third cell (cell 2) transmits a third FMCW from frequency f₂ to frequency f₂+B. During a second measurement 1204, the second cell (cell 1) transmits the second FMCW from frequency f₀ to frequency f₀+B. The third cell (cell 2) transmits the third FMCW from frequency f₁ to frequency f₁+B, and the first cell (cell 0) transmits the first FMCW from frequency f₂ to frequency f₂+B. During a third measurement 1206, the third cell (cell 2) transmits the third FMCW from frequency f₀ to frequency f₀+B. The first cell (cell 0) transmits the first FMCW from frequency f₁ to frequency f₁+B, and the second cell (cell 1) transmits the second FMCW from frequency f₂ to frequency f₂+B. Thus, the narrowband FMCW is cyclically transmitted across cells.

As indicated above, FIGS. 4-12 are provided as examples. Other examples may differ from what is described with respect to FIGS. 4-12.

FIG. 13 is a flow diagram illustrating an example process 1300 performed, for example, by a user equipment (UE), in accordance with various aspects of the present disclosure. The example process 1300 is an example of

### Example Aspects

Aspect 1: A method of wireless communication by a user equipment (UE), comprising: receiving a first narrowband frequency modulated continuous wave (FMCW) reference signal from a first network device, the first FMCW reference signal having a pre-specified bandwidth; receiving a second narrowband frequency modulated continuous wave (FMCW) reference signal from a second network device, the second FMCW reference signal having the pre-specified bandwidth and being multiplexed with the first FMCW reference signal; and performing one-shot radio resource management (RRM) measurement based on the first FMCW reference signal and the second FMCW reference signal.

Aspect 2: The method of Aspect 1, in which performing the one-shot RRM measurement occurs during a synchronization signal (SS)/physical broadcast channel (PBCH) block measurement timing configuration (SMTC) window that is shorter than one millisecond.

Aspect 3: The method of Aspect 1 or 2, in which the first FMCW reference signal is multiplexed with the second FMCW reference signal in time, frequency, and/or code domain; and the method further comprises receiving time information, frequency information, and/or code information to enable demultiplexing the first FMCW reference signal from the second FMCW reference signal.

Aspect 4: The method of any of the preceding Aspects, in which the first FMCW reference signal and the second FMCW reference signal have a common slope.

Aspect 5: The method of any of the preceding Aspects, in which the pre-specified bandwidth depends on a frequency band of the first FMCW reference signal and the second FMCW reference signal.

Aspect 6: The method of any of the Aspects 1-4, in which the pre-specified bandwidth depends on a numerology of the first FMCW reference signal and the second FMCW reference signal.

Aspect 7: The method of any of the preceding Aspects, in which the first FMCW reference signal is frequency division multiplexed with the second FMCW reference signal, a frequency domain gap between the first FMCW reference signal and the second FMCW reference signal based on a maximum receive signal time difference (RSTD), the pre-specified bandwidth, and a time duration of the first FMCW reference signal and the second FMCW reference signal.

Aspect 8: The method of any of the Aspects 1-6, in which the first FMCW reference signal is time division multiplexed with the second FMCW reference signal in response to a frequency domain gap between the first FMCW reference signal and the second FMCW reference signal being less than a threshold value.

Aspect 9: The method of any of the Aspects 1-6, in which the first FMCW reference signal is code division multiplexed with the second FMCW reference signal in response to a frequency domain gap between the first FMCW reference signal and the second FMCW reference signal being less than a threshold value, the code division multiplexing comprising time or frequency scrambling for each narrowband FMCW signal.

Aspect 10: The method of any of the Aspects 1-6, in which the first FMCW reference signal is code division multiplexed with the second FMCW reference signal in response to a frequency domain gap between the first FMCW reference signal and the second FMCW reference signal being less than a threshold value, the code division multiplexing occurring for a group of narrowband FMCW signals across cells.

Aspect 11: The method of any of the preceding Aspects, in which: receiving the first FMCW reference signal and receiving the second FMCW reference signal during a first time window; and receiving the first FMCW reference signal and receiving the second FMCW reference signal during a second time window.

Aspect 12: The method of any of the preceding Aspects, further comprising: mixing the first FMCW reference signal with a narrowband FMCW signal to obtain a first cluster of beat signals, the first cluster corresponding to a first plurality of multipath frequencies from a first cell; mixing the second FMCW reference signal with the narrowband FMCW signal to obtain a second cluster of beat signals, the second cluster corresponding to a second plurality of multipath frequencies from a second cell; matching the first cluster of beat signals with time information, frequency information, and/or code information for the first FMCW reference signal transmitted from the first cell to enable the one-shot RRM measurement of the first cell; and matching the second cluster of beat signals with time information, frequency information and/or code information for the second FMCW reference signal transmitted from the second cell to enable the one-shot RRM measurement of the second cell.

Aspect 13: The method of any of the preceding Aspects, further comprising: receiving the first FMCW reference signal in a first frequency band and receiving the second FMCW reference signal in a second frequency band during a first time window; and receiving the first FMCW reference signal in the second frequency band and receiving the second FMCW reference signal in the first frequency band during a second time window, in accordance with a cyclical sweep.

Aspect 14: An apparatus for wireless communication by a user equipment (UE), comprising: at least one memory; and at least one processor coupled to the at least one memory, the at least one processor configured: to receive a first narrowband frequency modulated continuous wave (FMCW) reference signal from a first network device, the first FMCW reference signal having a pre-specified bandwidth; to receive a second narrowband frequency modulated continuous wave (FMCW) reference signal from a second network device, the second FMCW reference signal having the pre-specified bandwidth and being multiplexed with the first FMCW reference signal; and to perform one-shot radio resource management (RRM) measurement based on the first FMCW reference signal and the second FMCW reference signal.

Aspect 15: The apparatus of Aspect 14, in which the at least one processor is further configured to perform the one-shot RRM measurement during a synchronization signal (SS)/physical broadcast channel (PBCH) block measurement timing configuration (SMTC) window that is shorter than one millisecond.

Aspect 16: The apparatus of Aspect 14 or 15, in which the first FMCW reference signal is multiplexed with the second FMCW reference signal in time, frequency, and/or code domain; and the method further comprises receiving time information, frequency information, and/or code information to enable demultiplexing the first FMCW reference signal from the second FMCW reference signal.

Aspect 17: The apparatus of any of the Aspects 14-16, in which the FMCW reference signal and the second FMCW reference signal have a common slope.

Aspect 18: The apparatus of any of the Aspects 14-17, in which the pre-specified bandwidth depends on a frequency band of the first FMCW reference signal and the second FMCW reference signal.

Aspect 19: The apparatus of any of the Aspects 14-17, in which the pre-specified bandwidth depends on a numerology of the first FMCW reference signal and the second FMCW reference signal.

Aspect 20: The apparatus of any of the Aspects 14-19, in which the first FMCW reference signal is frequency division multiplexed with the second FMCW reference signal, a frequency domain gap between the first FMCW reference signal and the second FMCW reference signal based on a maximum receive signal time difference (RSTD), the pre-specified bandwidth, and a time duration of the first FMCW reference signal and the second FMCW reference signal.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by a user equipment (UE), comprising:
receiving a first narrowband frequency modulated continuous wave (FMCW) reference signal from a first network device, the first FMCW reference signal having a pre-specified bandwidth;
receiving a second narrowband frequency modulated continuous wave (FMCW) reference signal from a second network device, the second FMCW reference signal having the pre-specified bandwidth and being multiplexed with the first FMCW reference signal; and
performing one-shot radio resource management (RRM) measurement based on the first FMCW reference signal and the second FMCW reference signal.

2. The method of claim 1, in which performing the one-shot RRM measurement occurs during a synchronization signal (SS)/physical broadcast channel (PBCH) block measurement timing configuration (SMTC) window that is shorter than one millisecond.

3. The method of claim 1, in which the first FMCW reference signal is multiplexed with the second FMCW reference signal in time, frequency, and/or code domain; and
the method further comprises receiving time information, frequency information, and/or code information to enable demultiplexing the first FMCW reference signal from the second FMCW reference signal.

4. The method of claim 1, in which the first FMCW reference signal and the second FMCW reference signal have a common slope.

5. The method of claim 1, in which the pre-specified bandwidth depends on a frequency band of the first FMCW reference signal and the second FMCW reference signal.

6. The method of claim 1, in which the pre-specified bandwidth depends on a numerology of the first FMCW reference signal and the second FMCW reference signal.

7. The method of claim 1, in which the first FMCW reference signal is frequency division multiplexed with the second FMCW reference signal, a frequency domain gap between the first FMCW reference signal and the second FMCW reference signal based on a maximum receive signal time difference (RSTD), the pre-specified bandwidth, and a time duration of the first FMCW reference signal and the second FMCW reference signal.

8. The method of claim 1, in which the first FMCW reference signal is time division multiplexed with the second FMCW reference signal in response to a frequency domain gap between the first FMCW reference signal and the second FMCW reference signal being less than a threshold value.

9. The method of claim 1, in which the first FMCW reference signal is code division multiplexed with the second FMCW reference signal in response to a frequency domain gap between the first FMCW reference signal and the second FMCW reference signal being less than a threshold value, the code division multiplexing comprising time or frequency scrambling for each narrowband FMCW signal.

10. The method of claim 1, in which the first FMCW reference signal is code division multiplexed with the second FMCW reference signal in response to a frequency domain gap between the first FMCW reference signal and the second FMCW reference signal being less than a threshold value, the code division multiplexing occurring for a group of narrowband FMCW signals across cells.

11. The method of claim 1, in which:
receiving the first FMCW reference signal and receiving the second FMCW reference signal during a first time window; and
receiving the first FMCW reference signal and receiving the second FMCW reference signal during a second time window.

12. The method of claim 1, further comprising:
mixing the first FMCW reference signal with a narrowband FMCW signal to obtain a first cluster of beat signals, the first cluster corresponding to a first plurality of multipath frequencies from a first cell;
mixing the second FMCW reference signal with the narrowband FMCW signal to obtain a second cluster of beat signals, the second cluster corresponding to a second plurality of multipath frequencies from a second cell;
matching the first cluster of beat signals with time information, frequency information, and/or code information for the first FMCW reference signal transmitted from the first cell to enable the one-shot RRM measurement of the first cell; and
matching the second cluster of beat signals with time information, frequency information and/or code information for the second FMCW reference signal transmitted from the second cell to enable the one-shot RRM measurement of the second cell.

13. The method of claim 1, further comprising:
receiving the first FMCW reference signal in a first frequency band and receiving the second FMCW reference signal in a second frequency band during a first time window; and
receiving the first FMCW reference signal in the second frequency band and receiving the second FMCW reference signal in the first frequency band during a second time window, in accordance with a cyclical sweep.

14. An apparatus for wireless communication by a user equipment (UE), comprising:
at least one memory; and
at least one processor coupled to the at least one memory, the at least one processor configured:
to receive a first narrowband frequency modulated continuous wave (FMCW) reference signal from a first network device, the first FMCW reference signal having a pre-specified bandwidth;
to receive a second narrowband frequency modulated continuous wave (FMCW) reference signal from a second network device, the second FMCW reference signal having the pre-specified bandwidth and being multiplexed with the first FMCW reference signal; and
to perform one-shot radio resource management (RRM) measurement based on the first FMCW reference signal and the second FMCW reference signal.

15. The apparatus of claim 14, in which the at least one processor is further configured to perform the one-shot RRM measurement during a synchronization signal (SS)/physical broadcast channel (PBCH) block measurement timing configuration (SMTC) window that is shorter than one millisecond.

16. The apparatus of claim 14, in which the first FMCW reference signal is multiplexed with the second FMCW reference signal in time, frequency, and/or code domain; and the at least one processor is further configured to receive time information, frequency information, and/or code information to enable demultiplexing the first FMCW reference signal from the second FMCW reference signal.

17. The apparatus of claim 14, in which the FMCW reference signal and the second FMCW reference signal have a common slope.

18. The apparatus of claim 14, in which the pre-specified bandwidth depends on a frequency band of the first FMCW reference signal and the second FMCW reference signal.

19. The apparatus of claim 14, in which the pre-specified bandwidth depends on a numerology of the first FMCW reference signal and the second FMCW reference signal.

20. The apparatus of claim 14, in which the first FMCW reference signal is frequency division multiplexed with the second FMCW reference signal, a frequency domain gap between the first FMCW reference signal and the second FMCW reference signal based on a maximum receive signal time difference (RSTD), the pre-specified bandwidth, and a time duration of the first FMCW reference signal and the second FMCW reference signal.
